(19) United States
(12) Patent Application Publication
(10) Pub. No.: US 2006/0033419 A1
(43) Pub. Date: Feb. 16, 2006

(54) Image display device

(76) Inventors: Shigemi Hirasawa, Chiba (JP); Hiroshi Sasaki, Mobara (JP); Yuuichi Kijima, Chosei (JP); Hiroshi Kawasaki, Ooamishirasato (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/201,230

(22) Filed: Aug. 11, 2005

(30) Foreign Application Priority Data
Aug. 16, 2004 (JP) 2004-236286

(51) Int. Cl. H01J 63/04; H01J 1/62

(52) U.S. Cl. 313/495

(57) ABSTRACT

A cold cathode display device includes a plurality of spacers in a space defined between a face substrate and a back substrate. The spacers are held by two fixing means consisting of fixing by fusion of a fixing material and fixing by dissolution of the fixing material. The invention provides an image display device which can realize the large-sizing of display size, the high-quality display and the prolonged lifetime by preventing the inclination and the removal of the spacers thus assuring the fixing strength and ensuring the parallelism and the panel strength of both substrates.

### BACKGROUND OF THE INVENTION

The present invention relates to an image display device which makes use of the emission of electrons in a vacuum which is formed between a face substrate and a back substrate, and more particularly to an image display device having a prolonged lifetime which can maintain a parallelism of both substrates at a high level and, at the same time, can ensure a mechanical strength of a panel and the realization of large-sizing of a display size and a high quality display and a manufacturing method thereof.

As a display device which exhibits the high brightness and the high definition, color cathode ray tubes have been popularly used conventionally. However, along with the recent request for the higher quality of images of an information processing equipment or television broadcasting, the demand for planar displays (panel displays) which are light-weighted and require a small space while exhibiting the high brightness and the high definition has been increasing.

As typical examples, liquid crystal display devices, plasma display devices and the like have been put into practice. Further, particularly, as display devices which can realize the higher brightness, various types of planar display devices have been put into practice. Here, these planar display devices include an electron emission type display device or a field emission type display device as a display device which utilizes an emission of electrons from electron sources into a vacuum or an organic EL display which exhibits the low power consumption or the like.

Among such planar display devices, as the above-mentioned field emission type display device, there have been known a display device having the electron emission structure which was invented by C. A. Spindt et al, a display device having an electron emission structure of metal-insulator-metal (MIM) type, a display device having an electron emission structure which utilizes an electron emission phenomenon based on a quantum theory tunneling effect (also referred to as “a surface conduction type electron source”), and a display device which utilizes an electron emission phenomenon which a diamond film, a graphite film, carbon nanotubes or the like possesses.

Among these panel type display devices, the field emission type display is formed by laminating a face substrate which is provided with anode electrodes and phosphor layers on an inner surface thereof and a back substrate on which field-emission-type cathodes and control electrodes to each other with a gap of, for example, 0.5 mm or more, and these substrates are hermetically sealed to form a panel, and a sealed space which is defined between two substrates of the panel is held at a pressure lower than an atmospheric pressure of an ambient field or is evacuated into a vacuum.

Recently, as the field-emission type electron sources which constitute the cathodes of the planar display of this type, the use of carbon nanotubes (CNT) has been studied. The carbon nanotubes are formed by fixing a carbon nanotube aggregate which is formed by gathering a large number of extremely fine needle-like carbon compounds to the cathode electrode.

By applying an electric field to the cathode electrode having the carbon nanotubes, it is possible to allow the carbon nanotubes to emit electrons of high density with high efficiency and the phosphor is energized with these electrons thus providing various types of display devices or the flat panel display capable of displaying images or the like which exhibit the high brightness. This type of display device is disclosed in Japanese Patent Laid-open Hei11 (1999)-317164 (patent literature 1) and Japanese Patent Laid-open Hei8 (1996)-83579 (patent literature 2), for example.

FIG. 18 is a cross-sectional view of an image forming device of one conventional example disclosed in patent literature 1. This image forming device includes a face plate (face substrate) 1, a back plate (back substrate) 2, a support frame 3 which is arranged between the face substrate 1 and the back plate 2 and supports peripheries of these plates, and spacers 4 which are arranged between the face substrate 1 and the back plate 2. The face substrate 1 and the spacers 4 are bonded to each other using frit glass 7, while the back plate 2 and the spacers 4 are bonded to each other using frit glass 8. By bonding the face substrate 1, the back plate 2 and the support fame 3 using frit glass 9 at a bonding portion between the face plate 1 and the support frame 3 and at a bonding portion between the back plate 2 and the support frame 3, a panel (an assembled vessel) is formed. The respective frit glasses 7, 8, 9 are configured to possess softening temperatures which differ from each other.

In the drawing, numeral 5 indicates a group of electron emission elements and numeral 6 indicates image forming members.

In this manner, the patent literature 1 discloses the constitution in which the spacers 4 which constitute the support columns are arranged between the face substrate 1 and the back plate 2 so as to uniformly maintain a distance between the face substrate 1 and the back plate 2 over the whole surfaces of the substrates.

For example, as the image forming member 6, the constitution which provides an anode electrode and a phosphor layer on the face substrate has been known. Further, as a group of the electron emission elements 5, there has been generally known the structure which provides a cathode line, a field-emission-type electron source which is electrically connected with the cathode line and is formed for every pixel, and a grid electrode which is arranged close to the field-emission-type electron source in an electrically insulated manner and is formed for every pixel to the back substrate or the like.

With respect to the above-mentioned panel display which is constituted of two substrates, the plasma display (PDP) and the panel display having the metal-insulator-metal type electron sources (MIM-Display) also have the substantially equal constitution. Hereinafter, although the invention will be explained by taking the field-emission-type display device as an example, the invention is also applicable to the PDP and the MIM-Display in the substantially same manner. Further, the invention is also applicable to the display which uses the surface conduction elements (SED) in the substantially same manner.

Further, as a related art relevant to this type of panel display, besides the constitution described in the above-mentioned patent literature 1, patent literature 2, for example, discloses the constitution in which, stacked adhesion portions which are formed of a frit glass layer—a metal back layer—a frit glass layer on a black matrix BM on a phosphor screen of a face substrate, and a frit glass on the stacked adhesion portions is melted to fix spacers thus achieving the prevention of the peeling of the metal back layer and the prevention of positional displacement of the spacers.

### SUMMARY OF THE INVENTION

In the above-mentioned planar display device, the electrons emitted from the electron sources impinge on the phosphor body which constitutes the anode after passing through apertures formed in the control electrode and excite the phosphor body to emit light thus performing the display. Such an image display device provides the planar display which possesses excellent properties such as the high brightness and the high definition, is light-weighted and requires a small space.

However, in spite of such excellent structure, the planer image display device has the following drawbacks to be overcome. In the flat panel displays which use a cold cathode as an electron source including the display devices disclosed in the above-mentioned patent literatures 1 and 2, it is difficult to hold and fix the distance holding members (hereinafter referred to as spacers) arranged in the inside of a display region between both substrates in a state that the spacers are set free from the positional displacement and the inclination and hence, it is difficult to maintain the parallelism of both substrates and, at the same time, it is also difficult to ensure a sufficient panel strength.

Further, the conventional flat panel display has a drawback that the spacers are damaged and the electrodes or the like are damaged due to the damaged spacers. Further, in the conventional flat panel display, by adding a step to fix the spacers, there arises a possibility that cracks or leaks occur at hermetically sealed portions. There has been a demand for a technique which can overcome such drawbacks.

To fix the spacers and both substrates, in general, frit glass which is equal to the frit glass used as a material of the hermetic sealing material is used. In the crystallized frit glass, the crystallization progresses due to heating for a long time, and physical property values such as the thermal expansion coefficient and the like are changed whereby there arises a possibility that cracks occur due to an impact or the like and, at the same time, the hermetic sealing is damaged and hence, leaking is generated.

Further, the amorphous frit glass is softened due to the reheating temperature. Accordingly, the spacers which are once fixed by softening suffer from the positional displacement or the inclination whereby it is difficult to allow the amorphous frit glass to hold and fix the spacers at desired positions with high accuracy. Further, when the amorphous frit glass is used, also due to the generation of the deflection of the substrate or the like, it is difficult to maintain the parallelism of both substrates and to ensure the panel strength. Further, there also arises a drawback that spacers are damaged.

On the other hand, in the constitution which selectively uses plural kinds of frit glasses having different softening temperatures for fixing the spacers as disclosed in the patent literature 1, in general, the frit glasses have properties which exhibit softening gradually depending on kinds thereof. For example, the softening starts from a temperature approximately 50° C. lower than a nominal value and hence, the fluctuation of temperature is taken for granted.

Accordingly, even when the plural kinds of frit glasses whose softening temperature difference is approximately 50° C. or less are selectively used, it is almost impossible to hold the spacers in a state where the spacers are practically set free from the positional displacement and the inclination. Further, it is practically impossible to selectively use the plural kinds of frit glasses whose softening temperature difference exceeds 50° C. Accordingly, there has been a demand to cope with such drawbacks.

Further, with respect to the constitution disclosed in patent literature 2 which provides the stacked adhesion portions formed of the frit glass layer—the metal back layer—the frit glass layer on the black matrix BM of the phosphor screen, since the metal back layer is interposed between the frit glass layers, the upper and lower frit glass layers are difficult to melt, whereby there has been a demand for further enhancement with respect to the reliability of holding spacers.

Further, in the related art which includes patent literature 2, jigs or the like are indispensable for holding spacers at the time of adhering and fixing the spacers and holding the spacers during the manufacturing steps after such adhering and fixing, this has brought about drawbacks that spacers, electrodes and the like are damaged or the operational efficiency is lowered during mounting or dismounting of the jigs or the like.

The invention provides an image display device and a manufacturing method thereof which can overcome the above-mentioned drawbacks, and can ensure a panel strength while holding the parallelism between both substrates by ensuring the fixing of spacers, can realize a large-sized display and a high quality display, and can also prolong a lifetime thereof.

To overcome the above-mentioned object, the invention is characterized by the constitution which fixes spacers to a substrate using the composite fixing structure by way of fixing materials and the arrangement of spacers.

Due to such a constitution, it is possible to obtain the reliable fixing of the spacers thus ensuring the parallelism of both substrates and the strength of the panel.

The invention has the following advantages.

(1) In the invention, it is possible to surely adhere and fix the spacers and both substrates and hence, a distance between both substrates can be held at a desired value by the cooperation of the spacers and a frame. Further, the invention can also enhance a mechanical strength of a panel. Still further, the invention can realize the large-sized display and the high-quality display, leading a display device with prolonged lifetime.

(2) With the use of the combination of fixing by fusion and fixing by dissolution, the invention can surely adhere and fix the spacers and the substrates and, at the same time, can prevent the occurrence of damages on electrodes and the like thus realizing the electrodes or the like which exhibit high quality and high performance.

(3) The invention uses the combination of fixing by fusion and fixing by dissolution and hence, the spacers and the substrates can be surely adhered and fixed to each other whereby the operability is enhanced.

(4) The invention uses the combination of fixing by fusion and fixing by dissolution in adhering and fixing the spacers and both substrates and hence, the spacers and both substrates can be surely adhered and fixed to each other.

(5) In the invention, the bonding of conductive components and vitrifying components contained in the fixing material is strengthened and hence, the charging can be surely prevented and, at the same time, the spacers and both substrates can be surely adhered and fixed to each other.

(6) In the invention, the fixing structure can be divided in two, that is, the fixing by fusion and the fixing by dissolution and hence, the operability can be enhanced. Further, the conductive components can be obtained stably at a low cost.

(7) In the invention, by forming the spacers using ceramics members, it is possible to provide spacers which have a mechanical strength necessary for a cold cathode display panel and, at the same time, it is possible to ensure the reliability of the adhesion and fixing of the spacers and both substrates.

In the invention, the spacers per se can be easily manufactured on a mass production basis and hence, it is possible to obtain the spacers at a low cost.

(9) In the invention, the spacers can hold the distance between both substrates at a desired value over a whole surface of the substrate in cooperation with the frame and, at the same time, the mechanical strength of the panel can be enhanced, whereby it is possible to realize the image display device which enables the large-sizing of the display and the high-quality display and also possesses the prolonged lifetime.

(10) In the invention, by setting the distance between the spacers to 50 mm or less, it is possible to reduce a distortion of a display image attributed to the deflection of the substrate.

(11) The invention can provide the constitution which exhibits the high reliability with respect to both of the adhering and fixing of the spacers and the substrate and the hermetic sealing of the frame and the substrate, and can realize, not to mention the enhancement of operability, the image display device which enables the large-sizing of the display and the high-quality display and also possesses the prolonged lifetime.

(12) It is possible to enhance the operability by making use of the fixing by fusion and the fixing by dissolution.

(13) The use of jigs and the like is not indispensable and hence, it is possible to obviate the various drawbacks attributed to the jigs and hence, it is possible to realize the image display device which enables the large-sizing of the display and the high-quality display and also possesses the prolonged lifetime.

(14) Further, there is no generation of the positional displacement or the inclination of the spacers. Further, there is neither breaking of the spacers nor damages on the electrodes or the like attributed to the broken spacers.

### BRIEF EXPLANATION OF DRAWINGS

FIG. 1 is a schematic plan view of one embodiment of an image display device of the invention;

FIG. 2 is a schematic cross-sectional view taken along a line A-A in FIG. 1;

FIG. 3 is a schematic cross-sectional view showing an essential part in FIG. 2 in an enlarged manner;

FIG. 4 is a schematic perspective view showing an essential part in FIG. 1 in an enlarged manner;

FIG. 5 is a plan view for explaining the relevant sizes of spacers, frames 3 and the like in FIG. 1;

FIG. 6A and FIG. 6B show another embodiment of the image display device of the invention, wherein FIG. 6A is a plan view of an essential part except the face substrate and FIG. 6B is a side view of FIG. 6A;

FIG. 7 is an enlarged cross-sectional view of an essential part showing another embodiment of the image display device of the invention;

FIG. 8 is a schematic plan view showing an example of a spacer layout pattern of another embodiment of the image display device of the invention;

FIG. 9 is a schematic plan view showing an example of a spacer layout pattern of another embodiment of the image display device of the invention;

FIG. 10 is a view for explaining the relationship between the vitrifying component ratio in a fixing material used in the image display device of the invention and an adhesive strength of the spacers;

FIG. 11 is a view for explaining the relationship between the vitrifying component ratio in a fixing material used in the image display device of the invention and a resistance value of the spacers;

FIG. 12 is a view for explaining the relationship between the arrangement interval of the spacers used in the image display device of the invention and a deflection quantity of the substrate;

FIG. 13 is a view for explaining the relationship between the arrangement interval of the spacers used in the image display device of the invention and a deflection quantity of the substrate;

FIG. 14 is a flow chart for explaining a manufacturing method of the image display device of the invention;

FIG. 15A and FIG. 15B are views for explaining the manufacturing method of the image display device of the invention, wherein FIG. 15A is a schematic plan view of an inner surface of a face substrate 1 and FIG. 15B is a side view of FIG. 15A;

FIG. 16 is a schematic view showing one example of a heat focusing means used in the manufacturing method of the invention;

FIG. 17 is a schematic view showing an essential part of a face substrate side in an enlarged manner for explaining the manufacturing method of the invention; and

FIG. 18 is a schematic cross-sectional view for explaining a conventional display device.

### DESCRIPTION OF THE PREFERRED EMBODIMENTS

Hereinafter, embodiments of the invention are explained in detail in conjunction with attached drawings of the embodiments.

### Embodiment 1

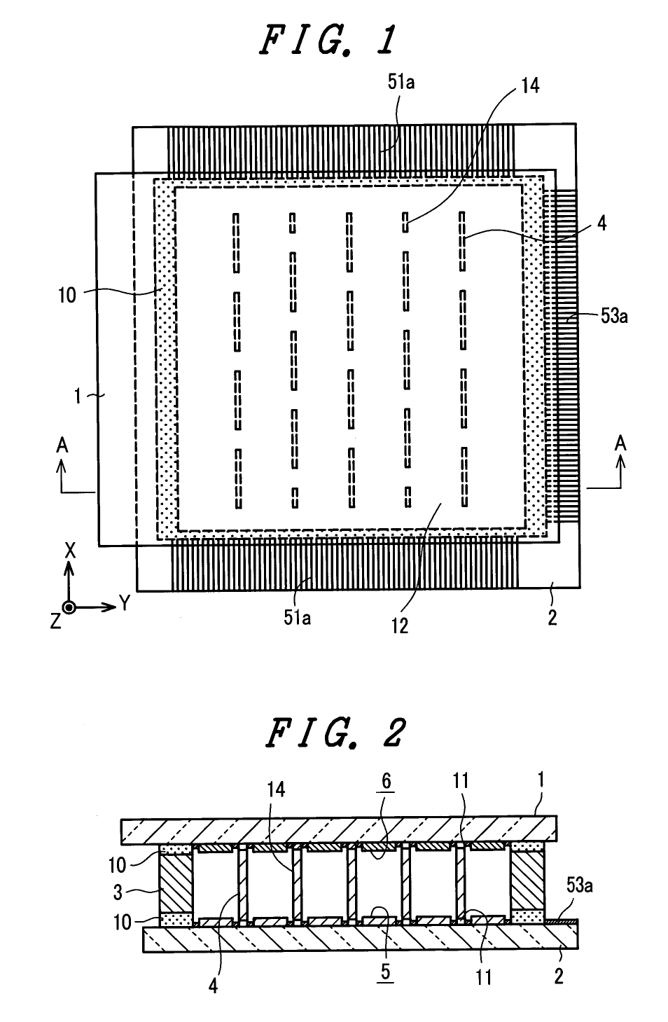

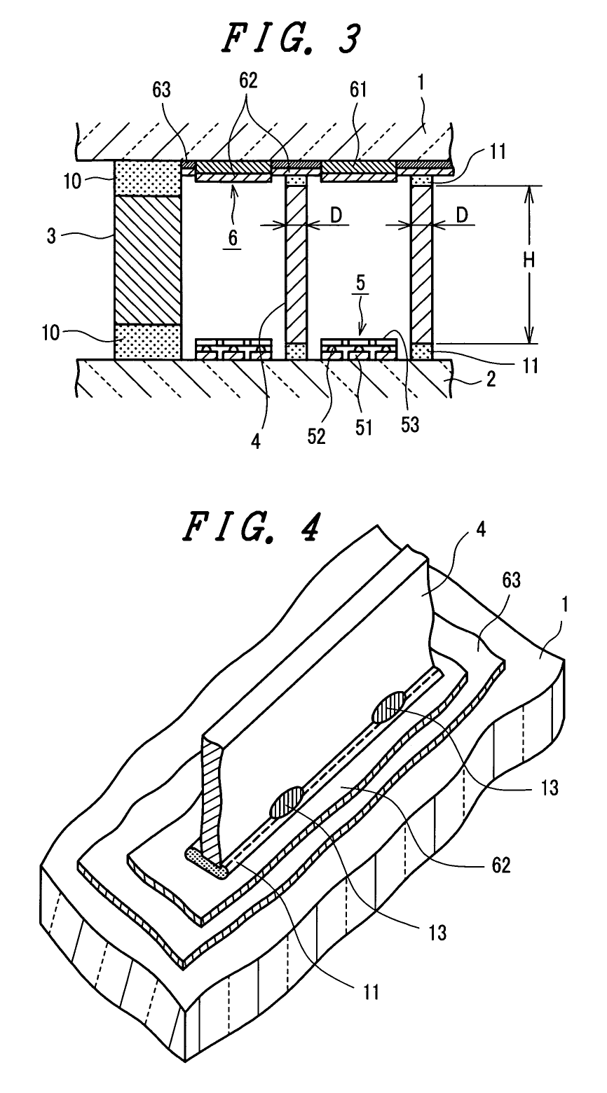

FIG. 1 to FIG. 4 show one embodiment of an image display device of the invention, wherein FIG. 1 shows an example of the image display device which uses cold cathodes as electron sources. Further, FIG. 1 is a schematic plan view of the schematic constitution as viewed from the face substrate side, FIG. 2 is a cross-sectional view taken along a line A-A in FIG. 1, FIG. 3 is an enlarged cross-sectional view of the essential part of FIG. 2, and FIG. 4 is a perspective view showing an essential part in FIG. 1 in an enlarged manner.

In FIG. 1 to FIG. 4, numeral 1 indicates a face substrate, numeral 2 indicates a back substrate, numeral 3 indicates a frame, numeral 4 indicates spacers, numeral 5 indicates a group of electron emitting elements, numeral 51 indicates cathode lines, numeral 51a indicates cathode line lead terminals, numeral 52 indicates electron sources, numeral 53 indicates control electrodes, numeral 53a indicates control electrode lead terminals, numeral 6 indicates an image forming member, numeral 61 indicates a phosphor layer, numeral 62 indicates a metal back layer, numeral 63 indicates a black matrix (BM) film, numeral 10 indicates a sealing material, numeral 11 indicates a fixing material, numeral 12 indicates a display region, and numeral 14 indicates short spacers.

In FIG. 1 to FIG. 4, the face substrate 1 is constituted of a transparent glass plate or the like, while the back substrate 2 is preferably constituted of an insulation substrate which is formed of glass or ceramics such as alumina or the like in the same manner as the face substrate 1 and has a plate thickness of several mm, for example, approximately 3 mm. The frame 3 which constitutes an outer frame, is arranged between peripheral portions of both substrates 1, 2, is formed of a glass plate or a shaped product of frit glass or the like, is fixed to both substrates 1, 2 by way of the sealing materials 10, and holds a distance between both substrates 1, 2 at a given size, for example, approximately 3 mm.

The plate-like spacers 4 and the short spacers 14 shorter than the plate-like spacers 4 are constituted of a thin ceramics plate made of alumina or the like. The plate-like spacers 4 and the short spacers 14 are arranged in a space defined between the face substrate 1 and the back substrate 2. Further, the spacers 4 and the short spacers 14 are erected on a surface of the above-mentioned substrate substantially vertically. A plurality of spacers 4 and short spacers 14 are arranged at a given pitch interval in a state that the spacers 4 and the short spacers 14 have a long-side direction thereof aligned with the above-mentioned one direction (X direction) (hereinafter referred to as “column”). A plurality of spacer columns are arranged at given pitch distances in another direction (Y direction) which intersects the above-mentioned one direction orthogonally. The spacers 4 and the short spacers 14 are fixed to the face substrate 1 by way of the fixing material 11 which contains a conductive component. Further, the spacers 4 and the short spacers 14 and the face substrate 1 are fixed to each other using two kinds of fixing methods consisting of fixing by fusion and fixing by dissolution. That is, the spacers and the substrates are fixed to each other using the composite fixing structure where the spacers and the substrates are fixed using a plurality of fixing means. The spacers 4 and the short spacers 14 and the back substrate are connected with each other only by fixing by dissolution.

The composite fixing structure of the face substrate 1 and the spacers 4, 14 is explained in detail in conjunction with FIG. 4.

The black matrix 63 is formed on the face substrate 1 and a metal back layer 62 which is constituted of an aluminum thin film is formed on the black matrix 63.

First of all, the spacers 4 and the short spacers 14 have portions thereof embedded in the fixing material 11 arranged on the metal back layer 62 of the face substrate 1. Next, portions of the above-mentioned embedded portions of the spacer are heated at a temperature of approximately 1000° C. or more, for example, using a heat focusing means such as laser irradiation thus locally melting the fixing material 11. The melted portions are solidified along with the lowering of temperature and forms fixing points 13. The fixing points 13 fix the spacers 4 and the short spacers 14 to the face substrate 1 by fusion by way of the fixing material 11.

Next, the temperature is elevated to a temperature at which the above-mentioned fixing material 11 is dissolved, for example, approximately 450° C. and remaining portions except for the melted fixing points 13 are dissolved thus further fixing the face substrate 1 and the spacers 4 and the short spacers 14 by dissolution.

Accordingly, the face substrate 1 and the spacers 4 and the short spacers 14 are fixed by the combination of the composite fixing structure of the fixing by fusion and the fixing by dissolution.

Although there may be a case in which traces of the above-mentioned irradiation may remain at portions of the spacers 4 and the short spacers 14 in the vicinity of the melting fixing point 13, the spacers per se and the fixing strength of the spacers receive no adverse influence.

Further, the above-mentioned fusion fixing point 13 may be decided based on the sizes, materials of the spacer and the working efficiency and the like.

On the other hand, the back substrate 2 and the spacers 4 and the short spacers 14 are fixed using the fixing by dissolution which dissolves the above-mentioned fixing material 11.

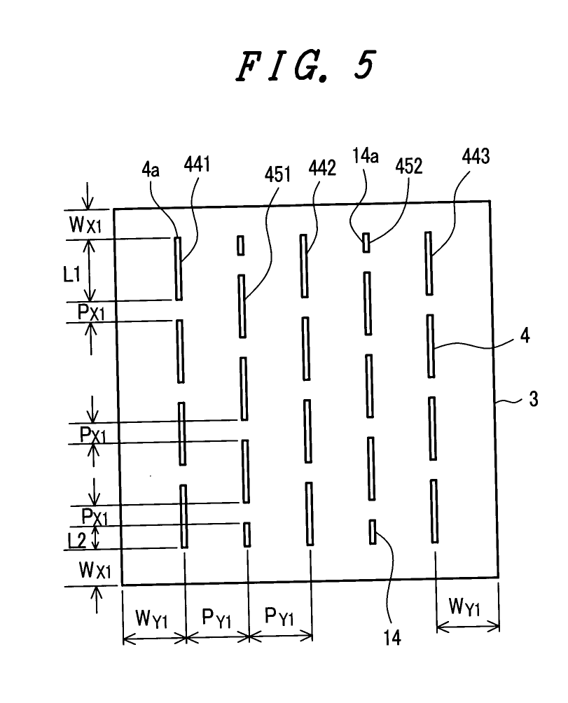

The arrangement pattern of the spacers held by such a fixing structure adopts the dispersion arrangement exhibiting a staggered pattern in which center positions of spacers 4 along long sides of the spacers 4 are displaced in one direction (X direction). That is, this embodiment uses both spacers which are constituted of the spacers 4 having a thickness D, a length L1 and a height H and the short spacers 14 which have the same thickness and the same height as the spacers 4 and only differ in length from the spacers 4. As the sizes or the like are described in detail in FIG. 5, the spacers 4 are arranged such that the long sides thereof are aligned in the above-mentioned one direction (X direction). Four spacers are arranged at a pitch interval Px1 forming columns (hereinafter referred to as four-piece columns) 441, 442, 443.

Further, the mixed columns 451, 452 are formed by aligning three spacers 4 at a pitch interval Px1 and two short spacers 14 at both ends. The four-piece columns and the mixed columns are configured to be arranged in parallel alternately at a pitch interval Py1 in another direction (Y direction) which intersects the above-mentioned one direction.

Further, in the four-piece columns 441 to 443, an interval in the aligning direction between the outermost spacer 4a in each column and the frame 3 is set as Wx1, while in the mixed columns 451 and 452, an interval in the aligning direction between the outermost spacer 14a in each column and the frame 3 is set as Wx1. Further, an interval in the arrangement direction between the outermost side columns 441 to 443 and the frame 3 is set to Wy1 (Wy1≈Wx1).

Further, the four-piece columns 441 to 443 and the neighboring mixed columns 451, 452 have the arrangement in which the centers of the long sides of the spacers 4 differ thus adopting the dispersion arrangement in which the arrangement pattern of the spacers 4 adopts the staggered pattern.

The spacers 4 and the short spacers 14 are arranged in a dispersed manner such that a stress attributed to an atmospheric pressure is substantially uniformly applied to the respective spacers 4 and the short spacers 14 so as to prevent the deflection and damages of the substrate and the generation of buckling of the spacers. Further, the respective spacers 4 and the respective short spacers 14 have upper and lower end surfaces thereof fixed to both substrates 1, 2 by way of the fixing material 11. Further, the spacers 4 and the short spacers 14 hold a distance between both substrates 1, 2 to a given size in cooperation with the frame 3.

Here, FIG. 5 is a plan view for explaining the relevant sizes of the spacers, the frame 3 and the like shown in FIG. 1. Here adopted is the constitution in which out of both substrates 1, 2 which are held at a given interval by the above-mentioned frame 3 and spacers 4, 14, a group of electron emitting elements 5 which are arranged on an inner surface of the back substrate 2 include cathode lines 51, electron sources 52 and grid electrodes 53 and the like.

A plurality of cathode lines 51 extend in one direction (X direction) and are arranged in parallel in another direction (Y direction) on the inner surface of the back substrate 2.

The cathode lines 51 have end portions thereof bifurcated as cathode-line lead lines 51a along two sides of the back substrate 2 and are pulled out to the outside of the hermetic sealing portion. The cathode lines 51 can be formed by vapor deposition or by baking. In forming the cathode lines 51 by baking, a silver paste which is formed by mixing low-fusion glass which exhibits the insulation property into conductive silver particles having a particle size of several μm (for example, approximately 1 to 5 μm) is printed to form a film of a large thickness and the film is baked at a temperature of approximately 600° C., for example.

Further, the control electrodes 53 are arranged above the cathode lines 51 in an insulated manner from the cathode lines 51. The control electrodes 53 constitute the control electrode lead lines 53a and are pulled out to the outside of the hermetic sealing portion at another one side of the back substrate 2.

Further, the electron sources 52 which are arranged on the cathode line 51 at a given pitch are formed of an electron emission element of metal-insulator-metal (MIM) type, an electron emission structure element which utilizes an electron emission phenomenon based on a quantum theory tunneling effect (also referred to as “a surface conduction type electron source”), or a diamond film, a graphite film and carbon nanotubes or the like. As a method for forming the electron sources 52, for example, a carbon nanotube paste is printed on a surface of the cathode line 51 which is formed by pressure membrance-printing and then baking and is baked in a vacuum at a temperature of 590° C., for example.

In this embodiment, as the carbon nanotube paste, a paste which is formed by dispersing single-wall carbon nanotubes in ethyl cellulose and terpineol is used.

Here, although the explanation has been made with respect to the single-wall carbon nanotubes above, the multi-wall carbon nanotubes or the carbon nanofibers maybe used. Further, besides these materials, for example, diamond, diamond-like carbon, graphite, amorphous carbon and the like can be used. Further, it is also possible to use the mixture of these materials.

Further, the image forming member 6 arranged on the face substrate 1 includes the phosphor layer 61, the metal back layer 62 which is formed on the phosphor layer 61 and the black matrix (BM) film 63. This constitution is substantially equal to the constitution of a conventional color-cathode-ray-tube phosphor screen.

In such a constitution, electrons emitted from the electron sources 52 which are arranged on the cathode lines 51 receive a control by electron passing holes formed in the control electrodes 53 to which a grid voltage of approximately 100V is applied and pass through the electron passing holes. Then, the electrons advance to the image forming members 6 to which an anode voltage of several KV to 10 and some KV is applied, pass through the metal back layers 62 (anodes) and impinge on the phosphor layers 61 thus allowing the phosphor layers 61 to emit light to perform a desired display on a video image screen.

Then, unit pixels are arranged on intersecting portions of the cathode lines 51 and the control electrodes 53 in a matrix array and the above-mentioned display region is formed of the matrix-arrayed pixels. In general, a group consisting of the above-mentioned three unit pixels constitutes a color pixel having colors of red (R), green (G) and blue (B).

Next, the sealing material 10 is made of amorphous frit glass which is, for example, composed of 75 to 80 wt % of PbO, approximately 10 wt % of B₂O₃ and 10 to 15 wt % of balance. The sealing material 10 is arranged on upper and lower end surfaces of the frame 3 and hermetically seals peripheral portions of the face substrate 1 and the back substrate 2 which are stacked in the Z direction. Due to such hermetic sealing, a portion surrounded by the frame 3 and both substrates 1, 2 constitute the display region 12.

Here, the hermetic sealing performed by way of the sealing material 10 is performed in a nitrogen atmosphere at a temperature of approximately 430° C. and, thereafter, the heating at a temperature of approximately 350° C., the evacuation and the sealing follow. Here, the Z direction means the direction which is orthogonal to substrate surfaces of the back substrate 2 and the face substrate 1 which are overlapped to each other.

Next, the fixing material 11 which fixes the spacers 4, the short spacers 14 and both substrates 1, 2 is constituted of a mixture of 50 wt % of a conductive component which is formed of conductive silver particles having a particle size of several μm to several tens μm (for example, approximately 3 to 10 μm) and 50 wt % of low-fusion-point frit glass which constitutes a vitrifying component which exhibits the insulation property. The fixing material 11 fixes the upper and lower end surfaces of the spacers 4 and both substrates 1, 2. The low-fusion-point frit glass is constituted of the composition which contains, for example, SiO₂, B₂O₃ and PbO as main components.

The fixing material 11 can be used in a state that the vitrifying component falls in a range of 10 to 90 wt %. When the vitrifying component of the fixing material 11 is less than 10 wt %, the adhesion strength becomes insufficient and hence, the spacers are removed or inclined whereby it becomes difficult to hold the parallelism between both substrates 1, 2 and, at the same time, it is difficult to ensure the desired panel strength. Further, there exists the possibility of the occurrence of defects such as the rupture of the spacers and damages on electrodes attributed to the rupture of the spacers when the adhesion strength decreases.

Further, the adhesion temperature at the time of adhering the spacers and the substrate is set based on the fusion characteristics of the conductive component. Accordingly, when the vitrifying component of the fixing material 11 is less than 10 wt %, the adhesion temperature becomes high. Accoridngly, there arises a problem with respect to the heat resistance of the electrodes, particularly the heat resistance of the electron sources 52. That is, there arise problems that the electrodes are damaged in the high-temperature adhesion and the adhesion strength becomes insufficient in the low-temperature adhesion thus giving rise to a drawback with respect to use as an image display device.

On the other hand, when the vitrifying component exceeds 90 wt %, an electric resistance value of bonding portions becomes high and a potential in the vicinity of the spacer 4 becomes unstable and hence, there arises the difference in a beam quantity among the electron beams which pass in the vicinity of the spacer 4 whereby the fluctuation of brightness and color tone is generated on a phosphor screen thus giving rise to a defect with respect to the display quality which does not allow the practical use of the display device.

Accordingly, the vitrifying component ratio can be used in a range of 10 to 90 wt %, while it is difficult to use the vitrifying component ratio which falls outside the range. Further, although the detailed explanation will be made later, it is desirable that the vitrifying component ratio practically falls within a range of 20 to 80 wt %, and it is more preferable that the vitrifying component ratio is approximately 50 wt % in view of the electric and mechanical properties as well as the operability.

Further, as the conductive components, beside the above-mentioned silver, for example, one selected from a group consisting of nickel, gold, platinum and the like or an alloy which contains such metals as a main component can be used. It is desirable to use a granular material which constitutes a sintered body of these metals. Particularly, it is preferable to use silver and nickel in view of the stable supply, inexpensive cost and, further, operability.

The upper and lower end surfaces of the spacer 4 and both substrates 1, 2 are fixed to each other with the above-mentioned fixing structure using the fixing material 11 having the above-mentioned composition.

In this embodiment, the fixing of the face substrate and the spacers is performed by the combination of a plurality of fixing structures consisting of the fixing by fusion and the fixing by dissolution and hence, it is possible to ensure the reliability of fixing of the substrate and the spacers.

Further, since the spacers 4 are accurately fixed to the substrate by fixing by fusion, even in the fixing by dissolution, it is possible to obviate the occurrence of the inclination and peeling-off of the spacers and hence, the breaking of the spacers or the damages on the electrodes can be obviated.

Further, since the spacers 4 are accurately fixed to the substrate by fixing by fusion, the use of the jigs which has been conventionally inevitable including a panel assembling step with the back substrate can be avoided and hence, not to mention the overcoming of the drawbacks attributed to the use of jigs, it is also possible to enhance the operability.

Further, by arranging plural types of combinations of the spacers 4 and the short spacers 14 having the size different from the spacers 4, the whole area of the substrate can be held uniformly. Accordingly, a stress attributed to an atmospheric pressure is substantially uniformly applied to the respective long and short spacers 4, 14 thus preventing the deflection and damages of the substrate and the generation of buckling of the spacers whereby it is possible to provide the highly reliable display device which can ensure the parallelism of both substrates and the panel strength.

Further, by setting the distances Wx1, Wy1 between the outermost spacers 4, 14 and the frame 3 substantially equal to the distances Px1, Px2 between the spacers, the outermost spacers 4, 14 hardly receive the influence of the fixing of the frame 3 and the sealing material 10 and hence, it is possible to hold the whole area of the display region 12 substantially uniformly.

Further, by allowing the aligning direction of the spacers and the extending direction of the cathode lines to be aligned with each other, it is possible to enhance the dielectric characteristics between the cathode lines. Further, by interposing, for example, a low-resistance metal layer as a third layer between the fixing material 11 and the spacers 4, 14, a potential of the spacers becomes more stable and hence, mislanding attributed to the diffusion of electron beams hardly occurs thus giving rise to an advantage that the image quality is enhanced.

### Embodiment 2

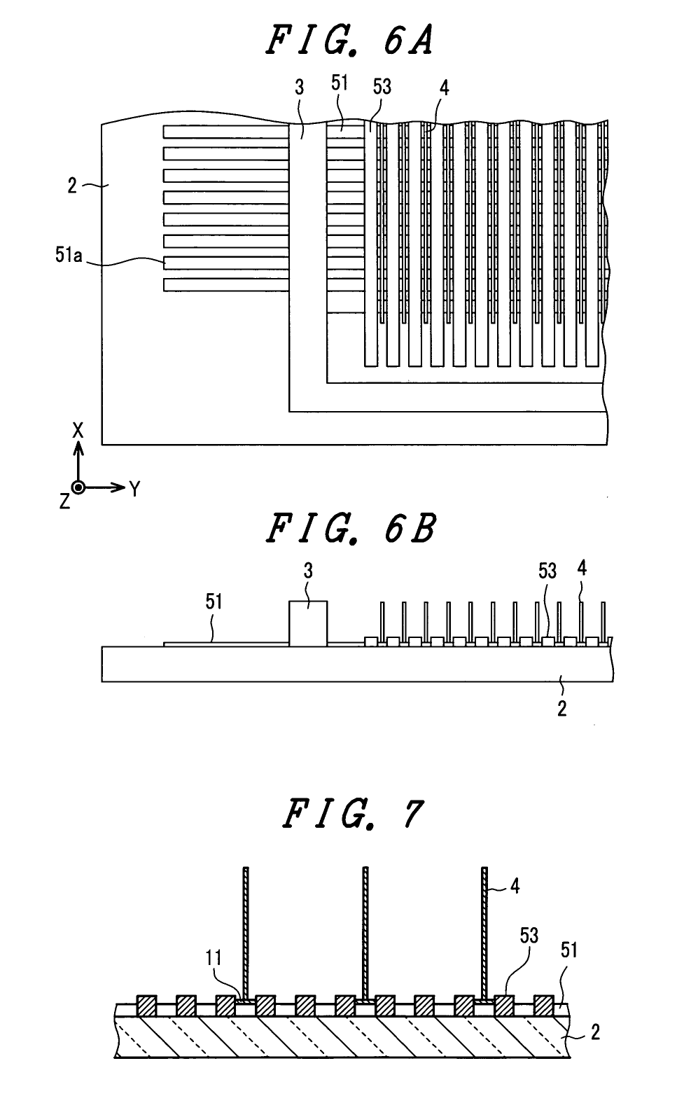

FIG. 6A and FIG. 6B show another embodiment of the image display device of the invention, wherein FIG. 6A is a plan view of an essential part showing the image display device by removing a face substrate and FIG. 6B is a side view of FIG. 6A. In these drawings, parts identical with the parts shown in the above-mentioned drawing or parts having functions identical with the functions of the parts shown in the above-mentioned drawing are given the same symbols.

This embodiment describes the constitution which fixes the spacers 4 to the back substrate 2 using the composite fixing structure. That is, in FIG. 6A and FIG. 6B, a plurality of cathode lines 51 extend in another direction (Y direction) and are arranged in parallel in one direction (X direction) on an inner surface of the back substrate 2. End portions of the cathode lines 51 are pulled out to the outside of the frame 3 of the back substrate 2 as cathode line lead lines 51a.

Further, the control electrodes 53 are arranged above the cathode lines 51 in a state that the control electrodes 53 cross the cathode lines 51 orthogonally and are insulated from the cathode lines 51. The end portions of the control electrodes 53 are pulled out to the outside of the support body 3 of the back substrate 2 as the control electrode lead lines.

On the other hand, each spacer 4 is arranged between the control electrodes 53 and in substantially parallel with the control electrodes 53 and has one end thereof fixed to the back substrate 2 by the composite fixing structure by way of the fixing material 11. In this composite fixing, to ensure the insulation between the cathode lines 51, when necessary, an insulation layer may be interposed between the fixing material 11 and the cathode lines 51.

According to this embodiment, by arranging the respective spacers 4 between all grid electrodes 51, it is possible to strengthen the holding strength of both substrates. Further, the trajectories of the electron beams can be controlled by the spacers and hence, the scattering of the electron beams can be reduced thus enhancing the brightness of a screen.

### Embodiment 3

FIG. 7 is an enlarged cross-sectional view of an essential part showing still another embodiment of the image display device of the invention. In this embodiment, parts identical with the parts shown in the above-mentioned drawing or parts having functions identical with the functions of the parts shown in the above-mentioned drawing are given the same symbols. Although the constitution which fixes the spacers 4 to the back substrate 2 by the composite fixing is equal to the corresponding constitution of the previous embodiment, the spacers 4 are arranged for every plural other control electrodes 53.

According to this embodiment, the operability of the spacer fixing operation can be enhanced and, at the same time, the embodiment is advantageous in view of a cost.

### Embodiment 4

FIG. 8 is a plan view showing an example of a spacer arrangement pattern of still another embodiment of the image display device of the invention, wherein parts identical with the parts shown in the above-mentioned drawing or parts having functions identical with the functions of the parts shown in the above-mentioned drawing are given the same symbols. In this embodiment, the plate-like spacers 4 are constituted of a thin ceramics plate made of alumina or the like and are arranged in a space defined between the back substrate 1 and the face substrate 2. Further, the spacers 4 are arranged in a state that the spacers 4 are erected on a substrate surface substantially vertically and long sides thereof are aligned with the above-mentioned one direction (X direction). Further, a plurality of spacers 4 are arranged at a given pitch distance (hereinafter referred to as “column”). A plurality of spacer columns are arranged at a given pitch distance in another direction (Y direction) which intersects the above-mentioned one direction orthogonally. Further, between the neighboring columns, the long-side center positions of the spacers 4 are displaced in one direction (X direction). That is, the spacers 4 are arranged in a staggered and dispersed manner.

That is, in this embodiment, the four-piece columns 441, 442, 443 each of which arranges four pieces of spacers 4 having a thickness D, a length L1, and a height H at a pitch interval Px1 while allowing the long sides of the spacers 4 to be aligned with the above-mentioned one direction (X direction) and the three-piece columns 431, 432 each of which arranges three pieces of spacers 4 at the same pitch Px1 are configured to be arranged in parallel in another direction (Y direction) which intersects one direction alternately at a pitch Py1.

Further, in the four-piece columns 441 to 443, the distance in the aligning direction between the outermost spacer 4a of each column and the frame 3 is set as Wx1, while in the three-piece columns 431, 432, the distance in the aligning direction between the outermost spacer 4b of each column and the frame 3 is set as Wx2 (Wx2>Wx1) and an envelope E which connects the outermost sides of these columns exhibits a serrated shape. Further, the distance in the arrangement direction between the outermost columns 441, 443 and the frame 3 is set to Wy1 (Wy1≈Wx1).

Further, the three-piece columns 431, 432 which are arranged close to the four-piece columns 441 to 443 have the center in the longitudinal-direction of the spacers 4 made different from each other thus providing the dispersed arrangement in which the spacers 4 are arranged in a staggered pattern.

The arrangement number and the arrangement position of the spacers are set such that a stress attributed to an atmospheric pressure is substantially uniformly applied to the respective arranged spacers 4. Further, the spacers 4 are arranged in a dispersed manner so as to prevent the deflection and damages of the substrate and the generation of buckling of the spacers. Each spacer 4 also have upper and lower end surfaces thereof fixed to both substrates 1, 2 by way of the fixing material 11. Further, the spacers 4 hold a distance between both substrates 1, 2 to a given size in cooperation with the frame 3.

According to the constitution of this embodiment, due to the proper arrangement of the spacers, it is possible to prevent the occurrence of damages on the spacers per se and, at the same time, a desired holding strength can be obtained with small number of spacers 4 due to the arrangement pattern indicated by an envelope E whereby the operability can be enhanced eventually. Further, with the use of single kind of spacers, the management of the operation is facilitated.

### Embodiment 5

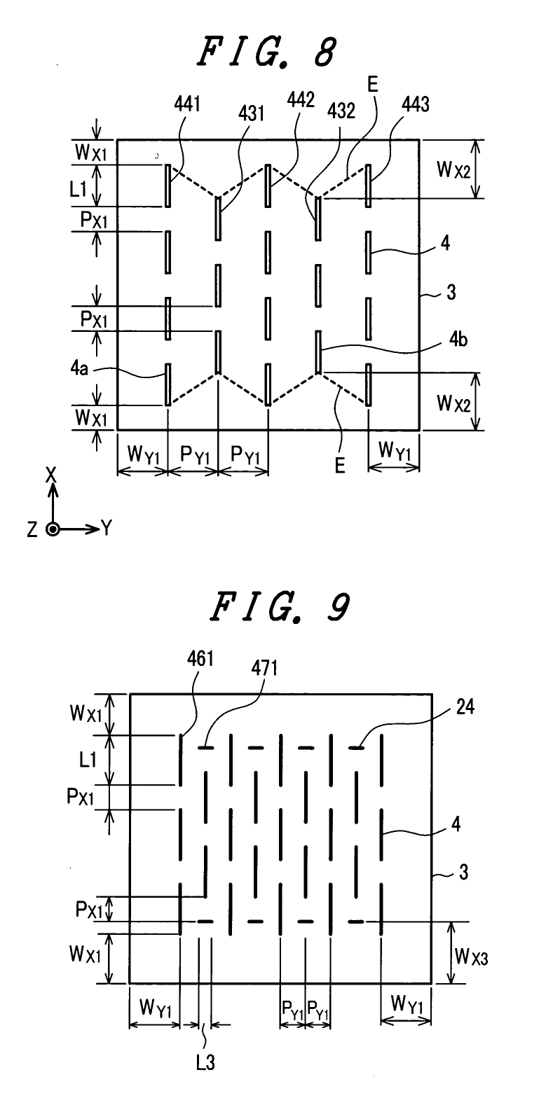

FIG. 9 is a plan view showing an example of a spacer arrangement pattern of still another embodiment of the image display device according to the invention, wherein parts identical with the parts shown in the above-mentioned drawing or parts having functions identical with the functions of the parts shown in the above-mentioned drawing are given the same symbols. In FIG. 9, in the long column 461, a plurality of spacers 4 are aligned in one direction. Further, in the composite column 471, the above-mentioned spacers 4 and spacers 24 having a length L3 which are shorter than the spacers 4 are combined and, at the same time, the length direction of the short spacers 24 adopts the orthogonal arrangement in which the length direction of the short spacers 24 is aligned with another direction which intersects the above-mentioned one direction. The long columns 461 and the composite columns 471 are alternately arranged in plural number in another direction which intersects the above-mentioned one direction and are also arranged in a staggered pattern.

A thickness and a height of the short spacers 24 are set equal to the thickness and the height of the spacers 4, while the distance Wx3 between the short spacer 24 and the frame 3 has the relationship of Wx3>Wx1.

According to this embodiment, with the use of the short spacers 24 and the long spacers 4, an approximately uniform load is applied to the respective spacers 4, 24 corresponding to respective sizes of the spacers 4, 24 and hence, it is possible to hold the distance between both substrates at a given size and, at the same time, it is possible to prevent the deflection and damages on the substrate and also the damages on the spacers.

Further, it is also possible to give rise to a reinforcing effect also in another direction which is orthogonal to the above-mentioned one direction and the whole area of the display region can be uniformly held provided that the relationship Wx3>Wx1 is satisfied.

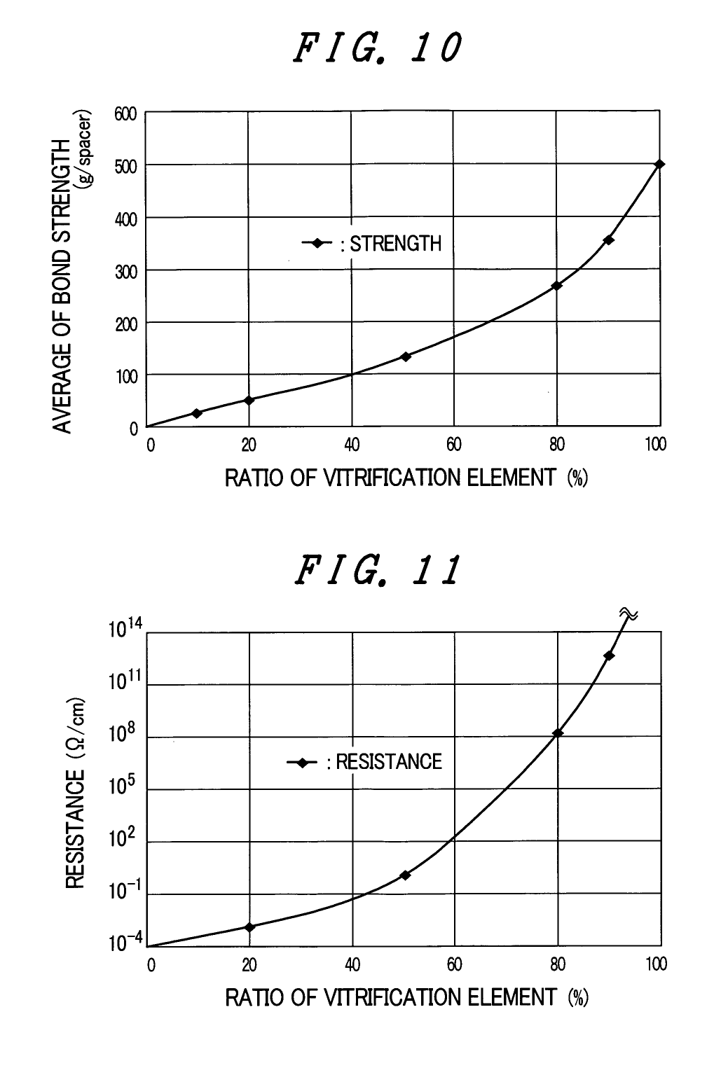

Next, FIG. 10 is a drawing which explains the relationship between a vitrifying component ratio in the fixing material used in the image display device of the invention and an adhesion strength of the spacers used in the image display device of the invention. In FIG. 10, the vitrifying component ratio (wt %) in the fixing material is taken on an axis of abscissas and an average adhesion strength (g/spacer) of the spacers is taken on an axis of ordinates.

Although the required adhesion strength of the spacers in this type of image display device is set by taking a safety coefficient at the time of assembling into consideration, it is empirically known that it is possible to obtain a sufficient adhesion strength by setting the safety coefficient to about 100 times or more of the weight of the spacer.

In FIG. 10, although a spacer having a thickness of 0.1 mm, a length of 85 mm, a height of 3 mm, a specific gravity of 4.1 is used as the spacers, the spacers having such a shape and size requires the adhesion strength of approximately 10 g or more.

In FIG. 10, when the vitrifying component ratio is 10%, the average adhesion strength becomes approximately 30 (g/spacer). Since the 3σ value is approximately ⅓ of the average adhesion strength, by taking the above-mentioned conditions into consideration, it is possible to obtain the required adhesion strength provided that the vitrifying component ratio is approximately 10% or more and it is possible to avoid the removal of spacers at the time of assembling. Accordingly, it is necessary to ensure the vitrifying component ratio of 10% or more.

Further, when this value exceeds 20%, as can be clearly understood from FIG. 10, the average adhesion strength is increased along with the increase of the vitrifying component ratio. That is, when the value is 50%, the average adhesion strength becomes approximately 130 (g/spacer), when the value is 90%, the average adhesion strength becomes approximately 350 (g/spacer), and when the value is 100%, the property of the average adhesion strength is rapidly changed and the average adhesion strength becomes approximately 500 (g/spacer) whereby the spacers are strongly fixed.

However, when the vitrifying component ratio is 100%, since the fixing material is constituted of only the vitrifying component, a resistance value becomes excessively high as described later thus giving rise to a drawback that the spacers are charged. In this manner, there arises the possibility that a locus of the electron beam is disturbed by charging. Due to the charging of the fixing material, there arises the possibility that it is less efficient to fix by fusion than expected and that the substrates and the spacers are excessively strongly fixed to each other thus hampering the recycling operation. Accordingly, it is desirable that the above-mentioned vitrifying component ratio in the fixing material is 90% or less.

Next, FIG. 11 is a view for explaining the relationship between a vitrifying component ratio in a fixing material used in the image display device of the invention and a resistance value of spacers used in the image display device of the invention. In FIG. 11, the vitrifying component ratio (wt %) in the fixing material is taken on an axis of abscissas and the resistance value (Ω/cm) of the spacers is taken on an axis of ordinates.

As can be clearly understood from FIG. 11, when the vitrifying component ratio exceeds 90%, the fixing material has the constitution similar to the fixing material which is formed of only the vitrifying component and hence, the resistance value becomes a value which exceeds 10¹²Ω/cm. When the vitrifying component exhibits such high resistance, there arises a drawback that the spacers are charged and this induces a drawback that a locus of electron beam is disturbed by charging. Accordingly, it is necessary to set the vitrifying component ratio to 90 wt % or less in view of the resistance value.

Further, it is preferable that the resistance value is practically 10¹⁰Ω·cm or less and hence, it is desirable to set the vitrifying component ratio to 80 wt % or less. On the other hand, when the vitrifying component ratio is lowered, the resistance value is also lowered as shown in the drawing.

However, it is necessary to prevent both substrates from becoming conductive with each other and hence, it is preferable to set the vitrifying component ratio to 10 wt % or more, and it is more preferable to set the vitrifying component ratio to 20 wt % or more.

Here, the material, the individual size, the number of arrangement, the arrangement pattern and the like of the spacers are determined by taking the sizes of the substrates, the number of pixels, the deflection quantity of both substrates, the operability and the like into consideration. Accordingly, with respect to the respective sizes of the spacers which are used in the above-mentioned FIG. 10, it is possible to adopt the specification which increases some lengths from three to nineteen times in view of the operability. However, the thickness and the height are highly likely to be set to values within several times in view of the constitution of the display device and hence, it is apparent that the above-mentioned vitrifying component ratio is not limited to the above-mentioned embodiments.

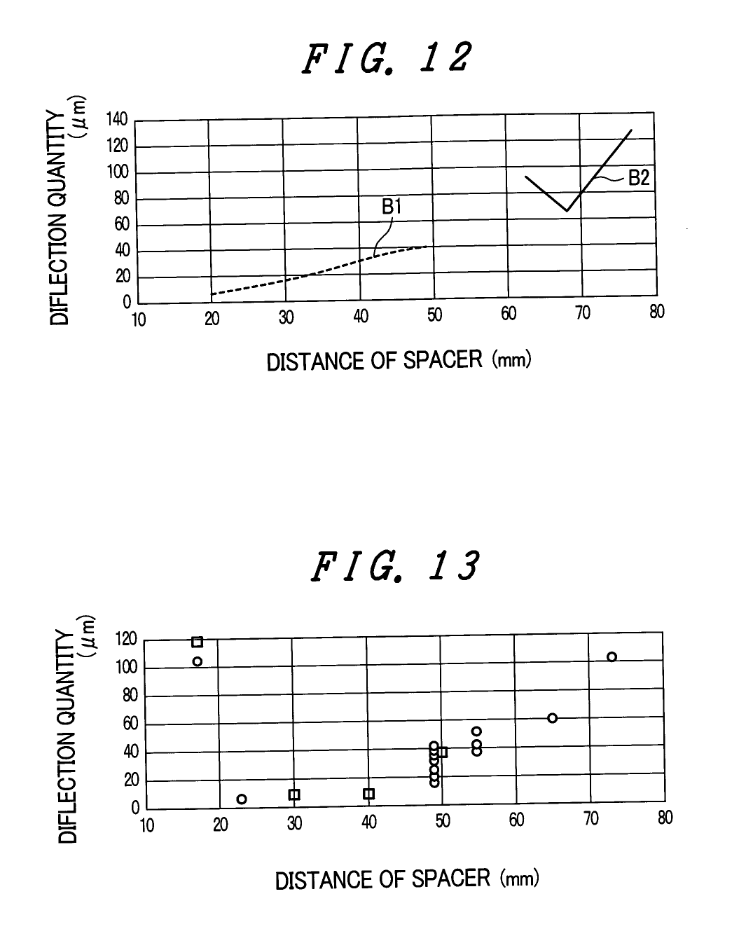

Next, FIG. 12 and FIG. 13 are views for explaining the relationship between the arrangement distance of spacers used in the image display device of the invention and a deflection quantity of a substrate used in the image display device of the invention. FIG. 12 shows the relationship between the pitch distance (Px1) of the spacers in one direction of one aligning direction (X direction) and the deflection quantity and FIG. 13 shows the relationship between the pitch distance (Py1) of the spacers in another direction of one arrangement direction (Y direction) which intersects one direction and the deflection quantity.

Here, in FIG. 12 and FIG. 13, as the spacers, spacers which have the specification of a ceramic plate having a thickness of 0.1 mm, a height of 3 mm and a length of 8.5 mm are used, while as both substrates, a 5-inch-size high strain point glass plate having a thickness of 2.8 mm is used. Further, as the fixing material, a silver paste having 50 wt % of vitrifying component is used.

First of all, in FIG. 12, the pitch distance (Px1) of the spacers in the above-mentioned aligning direction (X direction) and the distance (Wx1) in the aligning direction between the spacer 4 on the outermost column and the frame 3 are taken on an axis of abscissas and the deflection quantity is taken along an axis of ordinates. Further, a dotted line L1 indicates the deflection quantity at a center portion of the substrate and a solid line L2 indicates the deflection quantity at an end portion of the substrate. As shown in FIG. 12, when the pitch distance Px1 of the spacers is 20 mm, the deflection quantity at the center portion is approximately 10 μm and when the pitch distance Px1 is increased to 50 mm, the deflection quantity becomes approximately 40 μm.

In general, when the deflection quantity of the substrate is increased, the reflection on the screen is generated at the time of performing a display and hence, there arises a drawback that the display quality is deteriorated. To ensure the display quality by overcoming this drawback, it is necessary to limit the deflection quantity such that the maximum allowable deflection quantity of the substrate is approximately 40 μm. Accordingly, it is preferable to set the above-mentioned pitch distance Px1 to 50 mm or less.

On the other hand, with respect to the deflection quantity of an end surface of the substrate indicated by the solid line L2, irrespective of the value of the above-mentioned pitch distance Px1, when the distance Wx1 in the above-mentioned aligning direction exceeds 60 mm, the deflection quantity exceeds 60 μm and the reflection on the screen is generated. Accordingly, it is necessary to set the distance Wx1 in the aligning direction at the end surface to 50 mm or less in the same manner as the pitch distance Px1 at the center portion.

Next, in FIG. 13, the pitch distance (Py1) of the spacers in the above-mentioned parallel direction (Y direction) and the distance (Wy1) in the parallel arrangement direction between the spacer 4 on the outermost column and the frame 3 are taken on an axis of abscissas and the deflection quantity is taken along an axis of ordinates. Further, a square mark indicates calculated values and a circular mark indicates an actually measured value.

In FIG. 13, when the pitch distance (Py1) of the spacers and the distance (Wy1) in the parallel direction are approximately 55 mm or less, the deflection quantity also becomes 40 μm or less and hence, the generation of the reflection can be substantially eliminated. Further, when the pitch distance (Py1) of the spacers and the distance (Wy1) in the parallel arrangement direction becomes 50 mm or less, it is possible to eliminate the generation of the reflection more reliably. Accordingly, it is necessary to set the pitch distance (Py1) of the spacers and the distance (Wy1) in the parallel direction at the end surface to 50 mm or less in the same manner.

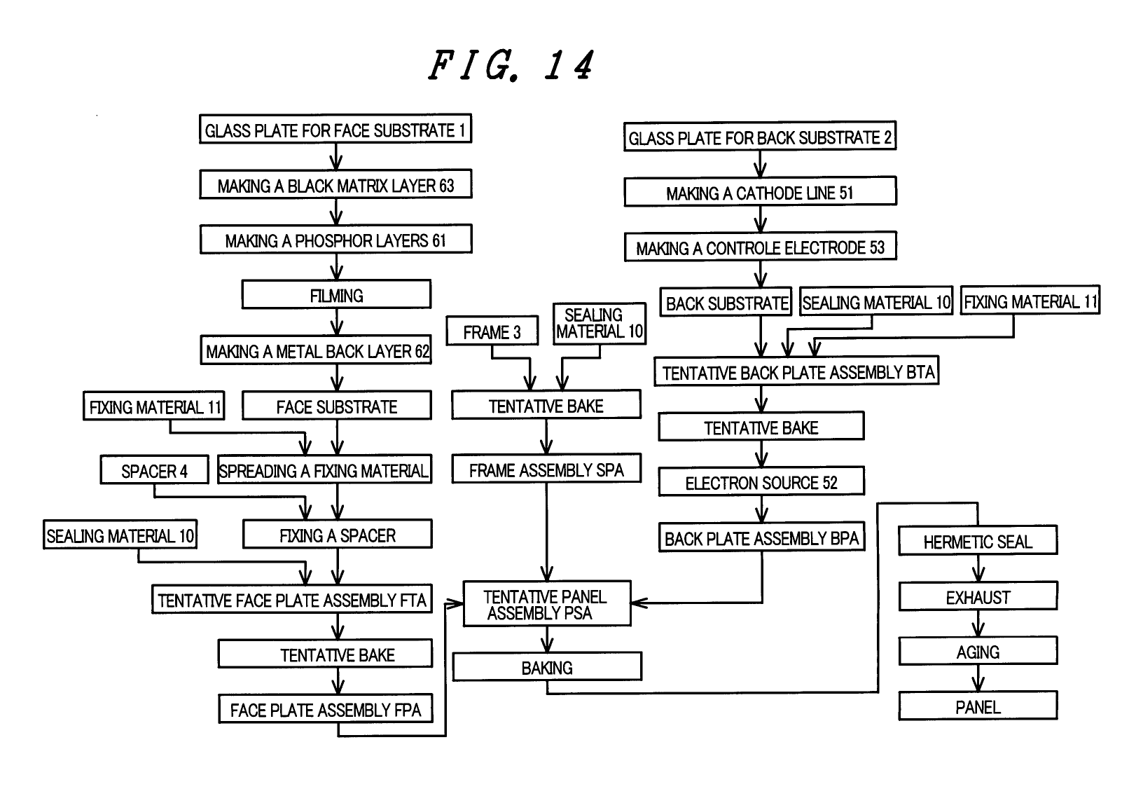

Next, the manufacturing method of the display device of the invention is explained. FIG. 14 is a flow chart for explaining the manufacturing method of the image display device of the invention, wherein parts identical with the above-mentioned parts explained in conjunction with FIG. 1 to FIG. 6 are given the same reference symbols.

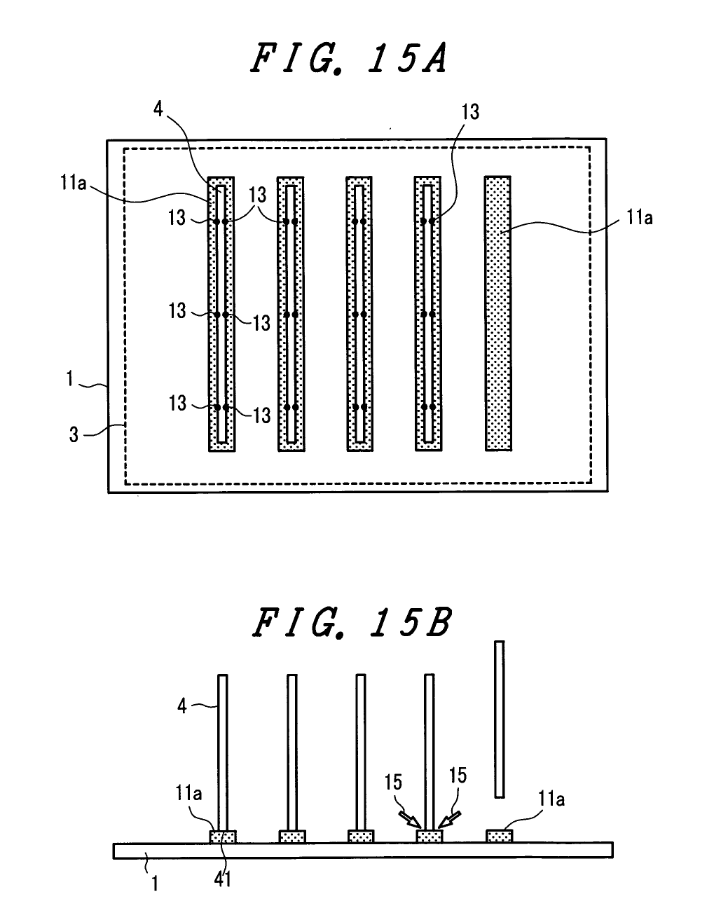

In FIG. 14, on the face substrate 1, the image forming members 6 constituted of the BM film 63, the phosphor pattern 61 and the metal back 62 are formed. Next, to the face substrate 1 on which the image forming members 6 are formed, the fixing material 11 which is mixed with a given binder is applied in a given pattern as shown in FIG. 15A using a dispenser thus forming a fixing material layer 11a.

Here, FIG. 15A and FIG. 15B are views for explaining the manufacturing method of the image display device of the invention, wherein FIG. 15A is a schematic plan view of an inner surface of the face substrate 1 and FIG. 15B is a side view of FIG. 15A, wherein parts identical with the above-mentioned parts explained in conjunction with drawings are given the same reference symbols.

Next, the spacers 4 are aligned with and mounted on the above-mentioned fixing material layers 11a, wherein one end side 41 of the spacer 4 is partially embedded in the fixing material layer 11a. This step is performed before drying the above-mentioned fixing material layer 11a.

Next, laser beams 15 or the like are irradiated to the vicinity of the one-end-side portion of the spacer 4 which is embedded in the fixing material layer 11a in a state that the spacer 4 is held. The beam-irradiated portion is heated at a temperature of 1000° C. or more, for example, to fuse the fixing material 11 and the spacer 4 is fixed to the face substrate 1 at the fusing fixing point 13.

In performing this fixing by fusion, besides the above-mentioned laser beams, it is possible to use a heating device which can heat the material to be heated 18 by the combination of an infrared light source 16 and an elliptical reflector 17 which is shown in FIG. 16 as an example. With the use of the heat focusing means which focuses laser beams, infrared rays and the like, it is possible to easily perform the management of operation in addition to the enhancement of the reliability of fixing and the operational environment. Here, FIG. 16 is a schematic view showing one example of the heat focusing means used in the manufacturing method of the invention.

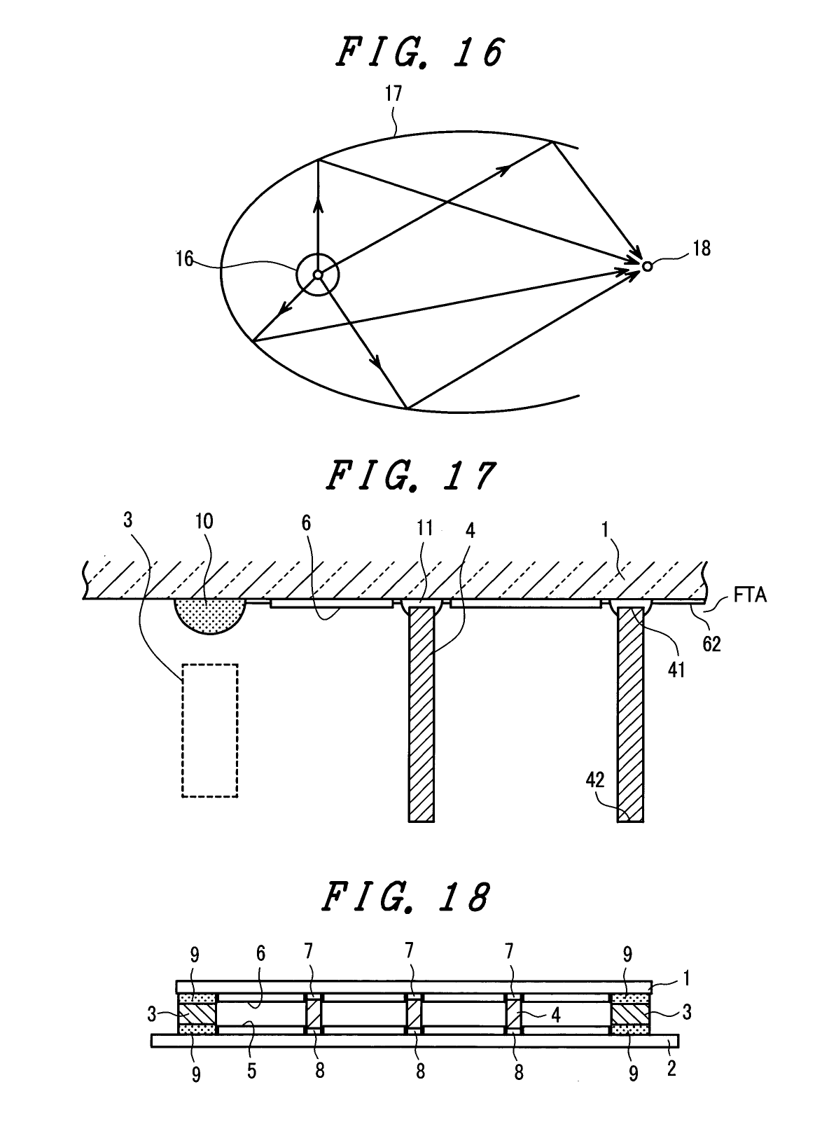

This fixing by fusion is performed at plural fusion fixing points 13 along the long-side direction of the spacer 4 thus fixing the spacer 4 to the face substrate 1 by fusion. A given number of spacers 4 are fixed by fusion to the face substrate 1 by repeating this step and, thereafter, the sealing material 10 in which a given binder is mixed is applied to the face substrate 1 thus constituting the face substrate provisional assembled body FTA shown in FIG. 17. Here, FIG. 17 is a schematic view showing an essential part of the face substrate side in an enlarged manner for explaining the manufacturing method of the invention.

Here, it is possible that the sealing material 10 is not formed on the substrate and the whole sealing material 10 is applied to the frame 3 side. Further, it is possible that the face plate 1 including the spacers 4 which are fixed by fusion is heated in the atmosphere at a temperature of 450° C., for example, for 10 minutes before applying the sealing material 10 and, thereafter, the heating for dissolution of the fixing material 11 is performed.

Next, the above-mentioned face plate provisional assembled body FTA is provisionally baked at an approximately 150° C. which is a temperature which can dissipate the binder thus forming the face substrate assembled body FPA.

On the other hand, on the back substrate 2 side, first of all, the plurality of cathode lines 51 which extend in the X direction and are arranged in parallel in the Y direction which intersects the X direction, the control electrodes 53 which extend in the Y direction and the like are formed. Thereafter, the fixing material 11 and the sealing material 10 to which the given binders are mixed respectively are applied and formed in given patterns thus forming the back substrate provisional assembled body BTA.

The back substrate provisional assembled body BTA is provisionally baked at a temperature of approximately 150° C. which can dissipate the binders and, thereafter, the electron sources 52 are formed on the cathode lines 51 to form the back substrate assembled body BPA.

Further, the sealing material 10 to which the given binder is mixed is applied to the upper and lower end surfaces of the frame 3 and, thereafter, the frame 3 is provisionally baked to form the frame assembled body SPA. Here, the temperature at the time of performing the provisional baking is set to approximately 150° C. or more which can dissipate the binder. When frit glass is used, it is possible to perform the baking operation at a temperature of approximately 350° C. to 450° C.

Next, a panel provisional assembled body PSA is formed by overlapping three assembled bodies, that is, the face substrate assembled body FPA which fixes one-end sides 41 of the spacers 4 to the face substrate 1 by fusion, the back substrate assembled body BPA and the frame assembled body SPA in the Z direction. While pressing the panel provisional assembled body PSA in the Z direction, the panel provisional assembled body PSA is heated at a temperature of 430° C. for 10 minutes, for example, thus hermetically sealing both substrates and the frame 3 using the sealing material 10 and, at the same time, one-end sides 41 of the spacers 4 are fixed to the face substrate 1 by fusion by way of the fixing material 11 while another-end sides 42 of the spacers 4 are fixed to the back substrate 2 by fusion by way of the fixing material 11.

Next, a space which constitutes an display region 12 surrounded by both substrates 1, 2 and the frame 3 is evacuated by way of an exhaust pipe not shown in the drawing. It is possible to perform the evacuating operation simultaneously with heating in the step for fusing the sealing material 10 and the fixing material 11 after arranging the panel provisional assembled body PSA in a vacuum furnace.

Here, it is needless to say that the invention is not limited to the above-mentioned embodiments and various modifications can be made without departing from the technical concept of the invention.

What is claimed is:

1. An image display device comprising:
a vacuum envelope including a face substrate which has an image display region, a back substrate which includes a plurality of electron sources and faces the face substrate in an opposed manner with a given distance therebetween, and a frame which surrounds an image display region and is arranged between the face substrate and the back substrate; and
a plurality of spacers which are arranged in the inside of the envelope, wherein
the spacers are fixed to the face substrate and the back substrate by way of a fixing material, and
the spacers is fixed to at least one of the face substrate and the back substrate using composite fixing structure by way of the fixing material.

2. An image display device according to claim 1, wherein the composite fixing structure adopts fixing by fusion of the fixing material and fixing by dissolution of the fixing material.

3. An image display device according to claim 2, wherein the spacer has one end side thereof fixed to the substrate using the composite fixing structure by way of the fixing material and has another end side thereof fixed to the substrate using one fixing structure by way of the fixing material.

4. An image display device according to claim 3, wherein the one fixing structure adopts fixing by dissolution of the fixing material.

5. An image display device according to claim 3, wherein the spacer has one end side thereof fixed to the face substrate using the composite fixing structure by way of the fixing material and has another end side thereof fixed to the back substrate using one fixing structure by way of the fixing material.

6. An image display device according to claim 1, wherein the fixing material contains metal particles having sinterability.

7. An image display device according to claim 6, wherein the metal particles having sinterability of the fixing material are one kind of metals selected from a group consisting of silver, gold, nickel and platinum or an alloy which contains the metals as a main component.

8. An image display device according to claim 1, wherein the spacers are formed of a plate-like ceramics member.

9. An image display device according to claim 1, wherein a plurality of spacers are arranged in one direction at a given pitch and are arranged in a plurality of columns in another direction which intersects the one direction.

10. An image display device according to claim 9, wherein the spacers which are arranged in the plurality of columns are arranged in a staggered pattern in which the centers of the spacers are displaced in one direction between the neighboring columns.

11. An image display device according to claim 10, wherein the plurality of spacers which constitute the columns have the same size in the one direction.

12. An image display device according to claim 10, wherein the plurality of spacers which constitute the columns differ in size in the one direction.

13. An image display device according to claim 10, wherein some of the plurality of spacers are arranged to have long sides in another direction which intersects the one direction.

14. An image display device according to claim 10, wherein the spacers are arranged in a plurality of columns and a distance between the columns is set to 50 mm or less.

15. An image display device according to claim 10, wherein a distance between the outermost spacer in the column and the frame differs between the neighboring columns.
